(19) United States
(12) Patent Application Publication
(10) Pub. No.: US 2006/0054098 A1
(43) Pub. Date: Mar. 16, 2006

(54) Methods and systems for modelling and controlling localized fish species habitats in a water body

(76) Inventors: Robert J. Congel, Fayetteville, NY (US); Robert D. Lusk, Sadler, TX (US)

Correspondence Address: JEFFREY L. BRANDT;c/o PORTFOLIO IP, P.O. BOX 52050, MINNEAPOLIS, MN, 55402, US

(21) Appl. No.: 11/212,502

(22) Filed: Aug. 26, 2005

Related U.S. Application Data
(60) Provisional application No. 60/607,092, filed on Sep. 3, 2004.

(51) Int. Cl. A01K 61/00

(52) U.S. Cl. 119/219

(57) ABSTRACT

Methods and systems for modeling, designing, controlling and optimizing fish niche habitats to encourage the grouping of fish species within particular locations or habitats in a body of water. The niche habitats are optimized for the comfort and health of the fish. Niche habitation improves fishing and other recreational experiences involving fish.

### BACKGROUND

Currently, bodies of water do not include particular locations optimized for specific fish species. That is, it is difficult if not impossible for fisherman or others to accurately anticipate the particular location of any particular fish species within a given body of water. Fish specie populations can roam at will within a body of water per their biological requirements. This does not support an optimal fishing experience where a sportsperson can maximize their opportunity for optimizing their catch rate of the species they wish. The selection of a fishing location is typically based on such factors as historical success and/or the judgment of a fisherman and may or may not be accurate at any particular time of any particular day.

### SUMMARY OF THE INVENTION

The present invention provides methods and systems for modeling, designing, controlling and optimizing fish niche habitats. The invention thus encourages the grouping of fish species within particular locations or habitats within a body of water, which habitats are optimized for the comfort and health of the fish. This provides many benefits, for example improving fishing and recreational experiences involving fish.

### DESCRIPTION OF THE DRAWING FIGURES

These and other objects, features and advantages of the invention will be apparent from a consideration of the detailed description of the invention when read in conjunction with the drawing Figures, in which:

FIG. 1 is a flow chart describing a process for designing, controlling and optimizing a body of water to create localized fish habitats (niched habitats) in accordance with the present invention.

### DETAILED DESCRIPTION OF THE INVENTION

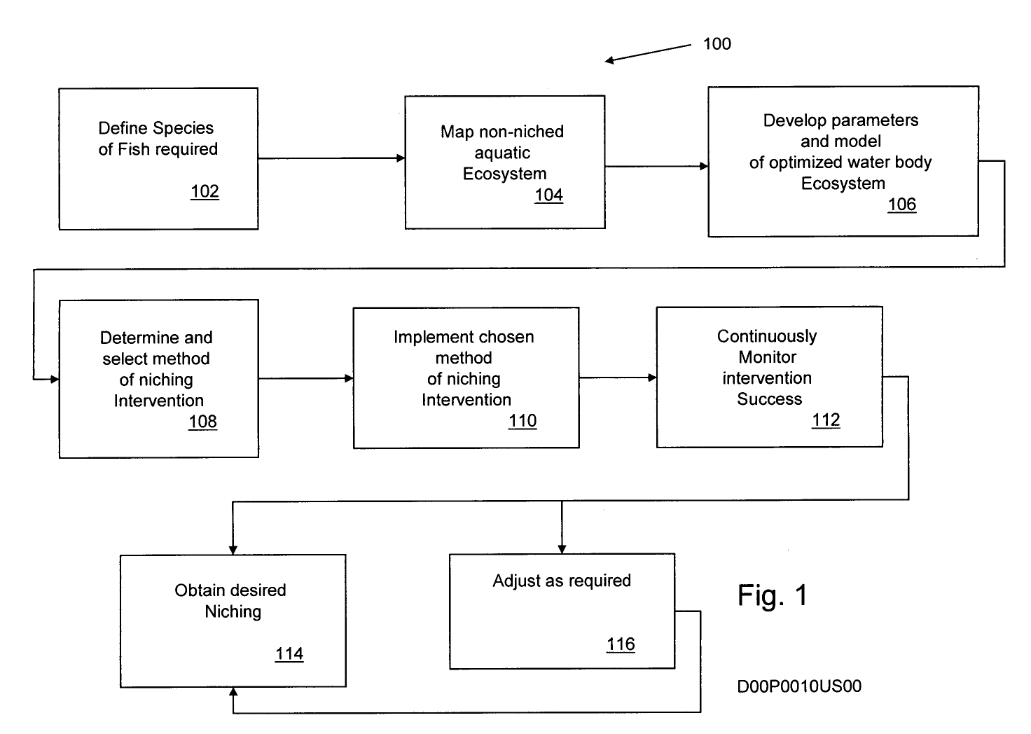

With reference to FIG. 1 there is shown a process 100 for designing, implementing, monitoring and controlling a water body so as to optimize it for specific fish species in specific water body locations. The fish species desired for niche optimization in the aquatic body and their optimal requirements for habitat are defined (step 102). The existing ecosystem of the aquatic body including water quality from a chemical (including but not limited to pH, metals, oxygen, nitrogen, phosphorous, potassium) and physical (including but not limited to temperature, water flow rates in to and within the water body and geologic structure all as a function of location) perspective; biological environment perspective (including but not limited to bacteria, flora, and structure); food chain (including but not limited to food chain options of flora, fish, micronutrient and external food additives) perspective and desired fish size, weight and growth rate are evaluated (step 104). The desired chemical, physical, food chain and biological qualities for the habitats within the body of water are defined and a model is developed for their implementation and control. (step 106).

Once the existing body of water conditions (input) and the desired body of water conditions/habitats (output parameters) are selected and modeled there is evaluated, selected and/or developed—as required—an appropriate method(s) for optimizing the desired habitats and thus fish specie locations in one or more particular geographic niches of the body of water. The options for intervention include, for example: alteration of water body physical structure and chemical parameters; specie habitat alteration from a biological, chemical and/or physical perspective; feature and attraction inclusion or modification including color, motion, lighting level; and feed composition. The method(s) of intervention are selected (step 108) based upon several criteria, including: i) compatibility with the water body environment, ii) ease of implementation, iii) cost to implement, iv) expected level of efficacy of intervention, v) ability to maintain and control to provide the desired specie location/niching results.

Upon implementation (step 110) of the selected methodologies the developed niches are continuously monitored using appropriate ones of or combinations of inline, online, real-time and remote monitoring to allow for continuous adjustment of intervention methodologies. Additional methodologies can be designed and implemented as necessary based upon changes in the input and output requirements.

There have thus been provided methods, processes, systems and controls for creating locally optimized niche fish specie environments which are compatible with and potentially enhancing to the environment and water bodies. When deployed in lieu of traditional, self-selected, naturally occurring localized fish habitats, the invention enables the optimization of human fishing and other recreational activities in an environmentally compatible environment.

What is claimed is:

1. A method for creating and controlling localized fish specie environments within a single body of water, comprising:
evaluating existing parameters of the body of water pertinent to fish species;
defining the desired quality of selected water body locations for optimizing specie growth and availability;
selecting the appropriate water processing method(s) for creating, controlling and maintaining the selected water body locations;
implementing the selected water processing methods; and
monitoring, controlling and adjusting the water processing methods for the selected water body locations for optimal fish specie populations.
